(19) United States
(12) Patent Application Publication
(10) Pub. No.: US 2016/0138738 A1
(43) Pub. Date: May 19, 2016

(54) Hose and Tubing Connector Device, Assembly and Method of Assembly

(71) Applicant: Quick Fitting, Inc., Warwick, RI (US)

(72) Inventors: David B. Crompton, Tiverton, RI (US); Libardo Ochoa Dias, Pawtucket, RI (US)

(21) Appl. No.: 14/585,921

(22) Filed: Dec. 30, 2014

Related U.S. Application Data
(60) Provisional application No. 62/080,763, filed on Nov. 17, 2014.

(51) Int. Cl. F16L 17/06

(52) U.S. Cl. CPC F16L 17/06

(57) ABSTRACT

A piping hose connector adapter can be employed as a stand-alone connector or integrated into a valve or fitting. The adapter can comprise a substantially cylindrical body having inner and outer walls, with a plurality of ledges extending radially outwardly from the outer wall and forming grooves therebetween. O-ring members can be inserted in one or more of the grooves. The adapter can be secured at one end to a fitting, and at the other end to a hose using a pressure applying device that can malform the hose around the outer surface of the adapter so as to compress the o-ring member.

### FIELD OF THE INVENTION

The present invention provides methods, connection devices as well as tooling designs for the permanent connection of flexible and rigid tubing with one or more fittings. In various embodiments, the tubing can be steel, brass, stainless steel or copper corrugated flexible or rigid tubing.

### BACKGROUND AND SUMMARY OF THE INVENTION

Piping systems exist to facilitate the flow of fluids (e.g., liquid, steam, gas (such as air) or plasma). For example, homes, schools, medical facilities, commercial buildings and other occupied structures generally require integrated piping systems so that water and/or other fluids can be circulated for a variety of uses. Liquids and/or gases such as cold and hot water, breathable air, glycol, compressed air, inert gases, cleaning chemicals, waste water, plant cooling water and paint and coatings are just some examples of the types of fluids and gases that can be deployed through piping systems. Tubing and piping types can include, for example, copper, stainless steel, CPVC (chlorinated polyvinyl chloride) and PEX (cross-linked polyethylene). For purposes of the present disclosure, the terms “pipe”, “piping”, “tube” or “tubing” will be understood to encompass one or more pipes, tubes, piping elements and/or tubing elements, and may be used interchangeably.

Piping connections are necessary to join various pieces of pipe and must be versatile in order to adapt to changes of pipe direction required in particular piping system implementations. For example, fittings and valves may be employed at the ends of open pieces of pipe that enable two pieces of pipe to fit together in a particular configuration. Among fitting types there are elbows, “tees”, couplings adapted for various purposes such as pipe size changes, ends, ball valves, stop valves, and partial angle connectors, for example.

In the past, pipe elements have been traditionally connected by welding and/or soldering them together using a torch. Soldering pipe fittings can be time-consuming, unsafe, and labor intensive. Soldering also requires employing numerous materials, such as copper pipes and fittings, emery cloths or pipe-cleaning brushes, flux, silver solder, a soldering torch and striker, a tubing cutter and safety glasses, for example. The process for soldering pipes can proceed by first preparing the pipe to be soldered, as the copper surface must be clean in order to form a good joint. The end of the pipe can be cleaned on the outside with emery cloth or a specially made wire brush. The inside of the fitting must be cleaned as well. Next, flux (a type of paste) can be applied to remove oxides and draw molten solder into the joint where the surfaces will be joined. The brush can be used to coat the inside of the fitting and the outside of the pipe with the flux. Next, the two pipes are pushed together firmly into place so that they “bottom out”—i.e., meet flush inside the fitting. The tip of the solder can be bent to the size of the pipe in order to avoid over-soldering. With the pipes and fitting in place, the torch is then ignited with the striker or by an auto-strike mechanism to initiate soldering. After heating for a few moments, if the copper surface is hot enough such that it melts when touched by the end of the solder, the solder can then be applied to the joint seam so that it runs around the joint and bonds the pipe and fitting together.

In addition to welding methods, push-fit technology has been employed with piping systems to reduce the dangers and time involved in soldering joints. Push-fit methods require minimal knowledge of pipe fittings and involve far fewer materials than soldering. For example, one may only need the pipes, quick-connect fittings, a chamfer/de-burring tool and tubing cutter in order to connect pipes using push-fit technology.

The steps involved in connecting piping systems using push-fit technology can be outlined as follows. First, the pipe is cut to the appropriate length and the end of the pipe is cleaned with the de-burring tool. Then the pipe and fitting are pushed together for connection. The fitting is provided with a fastening ring (also called a collet, grip ring or grab ring) having teeth that grip the pipe as it is inserted. The fastening ring device is employed to provide opposing energy, preventing the device from disconnection while creating a positive seal. Accordingly, no wrenches, clamping, gluing or soldering is involved. Push-fit and/or quick-connect technology for piping systems can be obtained, for example, through Quick Fitting, Inc. of Warwick, R.I., USA, suppliers of the CoPro®, ProBite®, LocJaw®, BlueHawk®, CopperHead® and PushConnect® lines of push fittings and related products. Also, such technology is described, for example, in U.S. Pat. No. 7,862,089, U.S. Pat. No. 7,942,161, U.S. Pat. No. 8,205,915, U.S. Pat. No. 8,210,576, U.S. Pat. No. 8,398,122, U.S. Pat. No. 8,480,134, U.S. Pat. No. 8,844,974 and U.S. Pat. No. 8,844,981, the disclosures of which are incorporated herein by reference in their entireties.

Among other things, the present invention provides a piping hose connector adapter that can be employed as a stand-alone connector or integrated into a valve or fitting, such as a ball valve as depicted in various drawings. In addition to the compression generated from clamping, the connection can be sealed by the compression of one or more peroxide cured EPDM seals (e.g., “O-rings”). The clamping method in accordance with aspects of the present invention crimps, then clamps the tubing to the hose adapter, which is shown as integrated on a push-fit valve in various drawings. Once the tubing is pushed on the adapter, one or more O-ring seals make contact with the inner diameter of the tubing for a secure seal and fit.

In various embodiments, the present invention employs existing corrugated or rigid tubing, which has been manufactured to a specific inside diameter, for example. The tubing can comprise, for example, stainless steel or copper corrugated flexible tubing, for example. The present invention requires no adhesives, no lubricants, no soldering and no glues. Additionally, various embodiments of the present invention operate with two retaining cavities. Once the tubing is formed into the cavities, the formed surfaces provide significant resistance to tensile forces, which prevents the failure of the connection under hydraulic hammering or higher pressures. As shown in the drawings, the adapter can be integrated into a push-to-connect ball valve. The valve adapter portion is pushed into the tubing. The assembly is placed in a crimping tool according to embodiments of the present invention to complete the process.

Once installed, the tubing rests against the adapter stop surface and the o-rings are compressed, providing a stiff connection of the assembly. The O-rings provide the assembler with the ability to hold the assembly in place while applying symmetrical force to the connection. As shown in the drawings, the tooling design is provided to mate the tubing to the adapter, which can be a brass material in various embodiments. The tool makes contact at the axially inward tip of the retaining arch, beginning the inward forming of the tubing. The tool also makes contact at the axially outward edge of the tube over an axially outer lip of the adapter, which can assist in preventing drift of the tube in an axially outward direction as the full crimping process occurs. The retaining arch forming prevents mal-forming of the sealing or crimped areas due to drift. The crimp tool in accordance with the present invention can be designed to be installed in a cylindrical hose crimping machine as indicated in various drawings herein. The tool in accordance with various embodiments of the present invention applies even force to the circumference of the connection area forming a water-tight seal and crimp. In various embodiments, the tooling evenly crimps the assembly on the outer diameter of the tubing. The newly formed channels compress the O-ring seal to exert greater compression of the seals and broaden the sealing surface area. It will be appreciated that the formed connection can be provided as lead-law compliant and full flow. The O-ring seals can be provided as chloramine resistant, exceeding the U.S. standard of temperatures up to 200 F, for example. Also, the crimped connection can resist tensile separation forces over 400 lbf on a ¾″ connection.

### BRIEF DESCRIPTION OF THE DRAWINGS

FIG. 1 is a top right perspective view of a valve with adapter in partially exploded form, in accordance with embodiments of the present invention.

FIG. 2 is a top right perspective view of an adapter in partially exploded form, in accordance with embodiments of the present invention.

FIG. 3 is a front cross-sectional view of a valve with adapter in accordance with embodiments of the present invention.

FIG. 4 is a detailed view of encircled portion 4-4 of FIG. 3.

FIG. 5 is a left end view of an embodiment of the adapter device in accordance with aspects of the present invention.

FIG. 6 is a front cross-sectional view of the embodiment of the adapter device taken along line 6-6 of FIG. 5.

FIG. 7 is a front elevational view of a valve with adapter aligned with a portion of a corrugated hose in accordance with assembly operations of embodiments of the present invention.

FIG. 8 is a front cross-sectional view of a valve with adapter, and with a portion of a corrugated hose placed over the adapter portion, in accordance with assembly operations of embodiments of the present invention.

FIG. 9 is a front elevational view of a valve with adapter and a portion of a corrugated hose, and further with a crimping device shown above and below the adapter portion in accordance with embodiments of assembly operations of the present invention.

FIG. 10 is a right front perspective view of the elements of FIG. 9.

FIG. 11 is a front cross-sectional view of an assembly in accordance with various embodiments of the present invention, with crimping device engaging the hose element.

FIG. 12 is a front cross-sectional view of the assembly of FIG. 11 with crimping device removed.

FIG. 13 is a view similar to FIG. 11 in accordance with embodiments of the present invention, with an alternative embodiment of a crimping device shown prior to crimping of the hose element.

FIG. 14 is a detailed view of encircled portion A-A of FIG. 13.

FIG. 15 is a rear cross-section view similar to FIG. 13 in accordance with embodiments of the present invention, after crimping of the hose element.

FIG. 16 is a detailed view of encircled portion B-B of FIG. 15.

FIG. 17 is a rear cross-sectional view similar to FIG. 15 in accordance with embodiments of the present invention, with crimping device removed.

FIG. 18 is a right end view of the crimping device in accordance with embodiments of the present invention.

FIG. 19 is a front elevational view of the device of FIG. 18.

FIG. 20 is a rear cross-sectional view of the device of FIG. 18 taken along line C-C of FIG. 18.

FIG. 21 is a detailed view of encircled portion D-D of FIG. 20.

FIG. 22 is a front elevational view of an adapter in accordance with embodiments of the present invention.

### DETAILED DESCRIPTION OF EMBODIMENTS

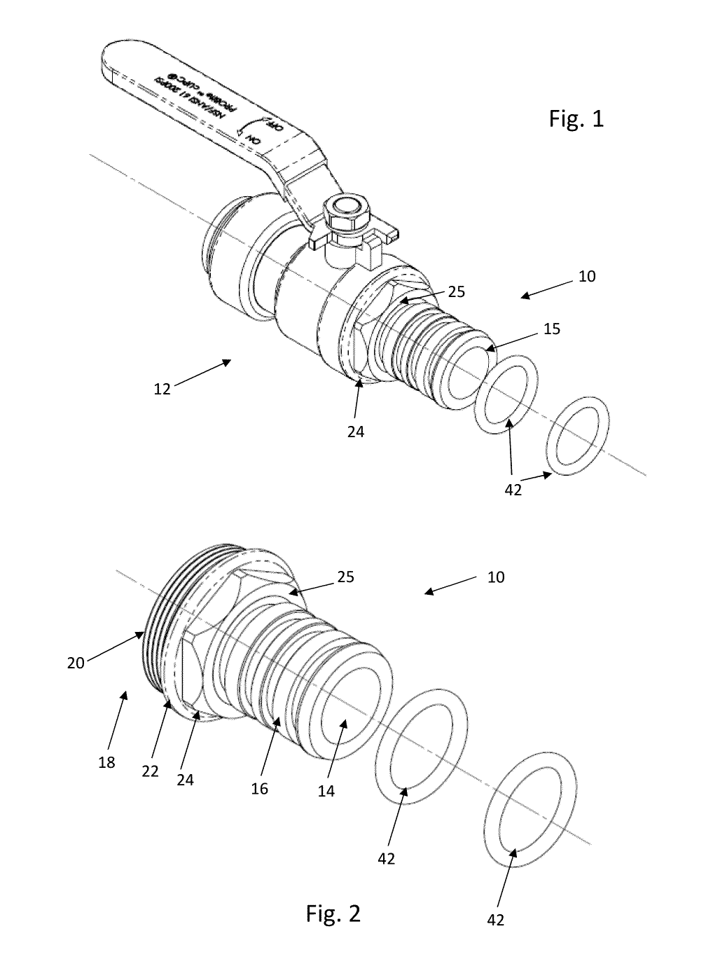

As shown in FIGS. 1 and 2, the present invention can be provided in various embodiments and with various components, including an adapter 10 which can be mated with a fitting 12 (e.g., the ball valve fitting shown at 12). The adapter 10 shown in FIGS. 1 through 6 is substantially tubular and/or cylindrical with an inner wall 14, an outer wall 16, a first axial end 18 with a threaded exterior 20 and a second axial end 19 with ledges 30, 34, 38, 40. The adapter further includes a rim 22 and a hexagonal or other similarly shaped annular edge 24 to assist, for example, in tightening and loosening the adapter 10 as it is secured to or removed from the fitting 12 in various embodiments. It will be appreciated that, while the adapter member 10 is shown with an axial end 18 having a threaded exterior 20 for a compression-type fitting connection, the adapter member 10 can also be provided with an axial end having a push-to-connect arrangement, such as may be described, for example, in U.S. Pat. No. 7,862,089, U.S. Pat. No. 7,942,161, U.S. Pat. No. 8,205,915, U.S. Pat. No. 8,210,576, U.S. Pat. No. 8,398,122, U.S. Pat. No. 8,480,134, U.S. Pat. No. 8,844,974 and U.S. Pat. No. 8,844,981 identified above. Such a push-to-connect arrangement can involve the fitting 12 having associated receiving structure, such as also described in the aforementioned patents. A wrench or other similar device can be securely placed around the edge 24 in order to grip the adapter for rotation such that the threaded exterior 20 engages with the threaded interior of the fitting 12, in the compression-type arrangement illustrated in FIGS. 1 through 3 and 6, for example.

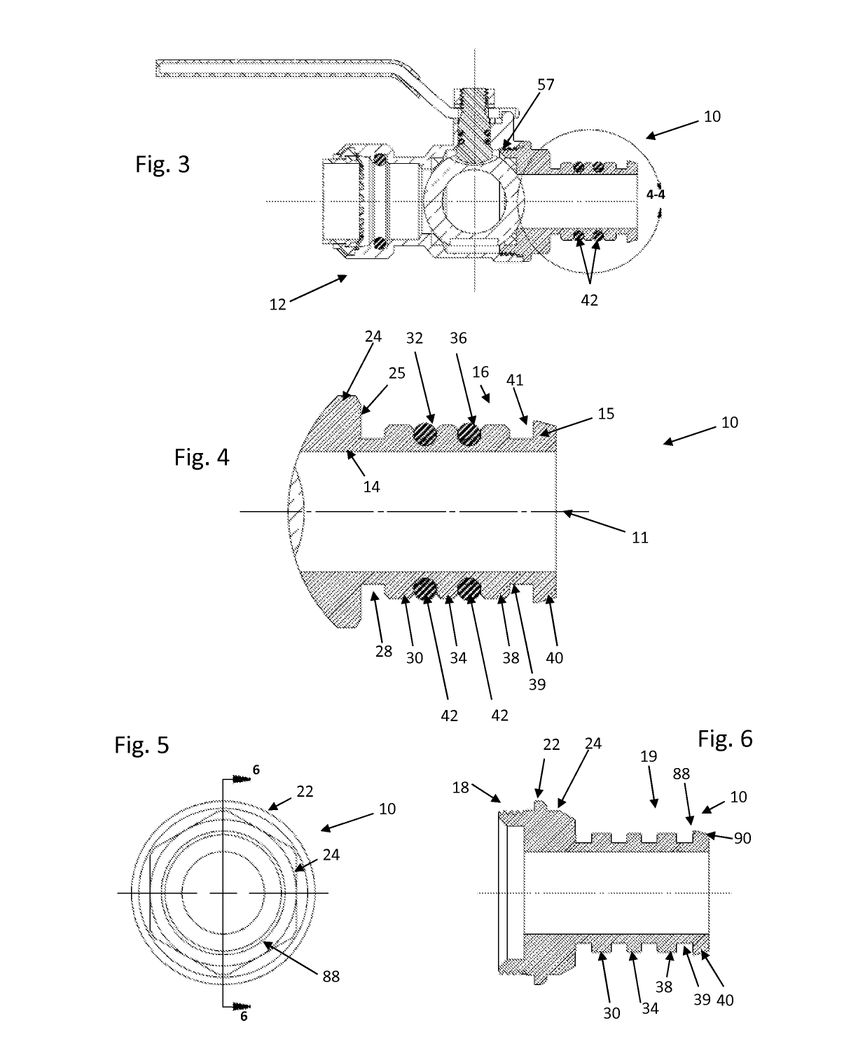

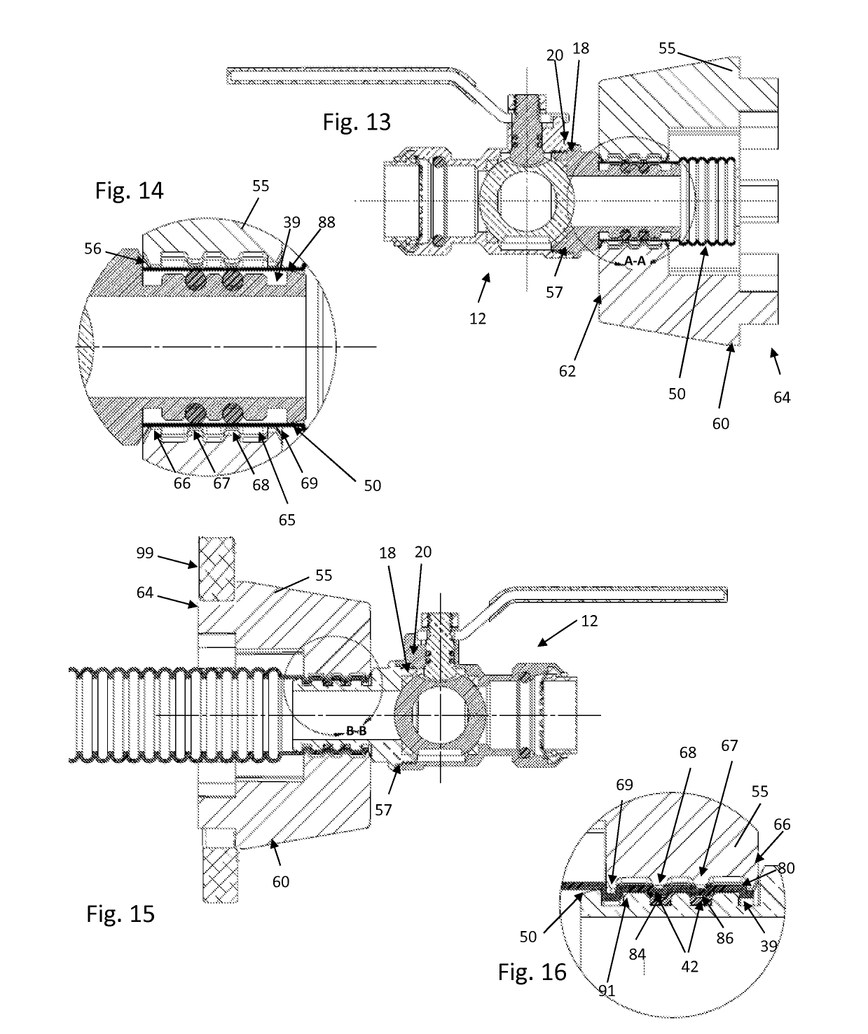

As shown in FIGS. 1 through 16, the adapter exterior 16 includes a stop surface 25 on the axially outer side of the annular edge 24, and further includes an axially interior groove 28 between the stop surface 25 and a first radial ledge 30. Extending axially outwardly from the interior groove 28 are the first radial ledge 30, a first o-ring groove 32, a second radial ledge 34, a second o-ring groove 36, a third radial ledge 38 and a fourth radial ledge 40. In various embodiments the grooves 28, 32 and 36 are provided such that the first and second o-ring grooves 32, 36 have an internal depth that extends radially inwardly and toward the adapter axis 11 farther than the internal depth of the interior groove 28. In other embodiments, the internal depths of the grooves can be substantially the same. In various embodiments, the radial ledges 30, 34, 38 and 40 are provided such that the first 30, second 34 and third 38 radial ledges extend substantially the same radial distance from the axis 11 of the adapter 10, while the fourth radial ledge 40 extends radially outwardly further from the axis 11. In this way, the fourth radial ledge 40 provides a circumferential lip 88 that assists in sealing a later-attached hose 50 around the adapter body portion 15. In various alternative embodiments, the first ledge 30 extends radially outwardly further than second 34 and third 38 ledges to provide an additional circumferential lip (not shown) that further assists in sealing a later-attached hose 50. In such embodiments, the first ledge 30 can extend radially outwardly approximately the same distance as fourth ledge 40 or radially further outwardly than fourth ledge 40. In various embodiments, the hose 50 is coined around the adapter body portion 15, including the fourth radial ledge 40, after one or more o-ring members 42 have been positioned in respective o-ring grooves 32, 36. The fourth radial ledge 40 can be sloped such that the lip 88 extends radially outwardly from the axis a further distance than the axially outermost edge 90 of the adapter member. In this way, the coining process for positioning the hose 50 around the adapter member is facilitated. FIGS. 3 and 4 show two o-ring members 42 in position, each within a respective o-ring groove 32, 36. In various embodiments of the present invention, a radially extending lip (not shown) can be provided between the stop surface 25 and the axially interior groove 28. The lip can assist in positioning when a crimping device 55 in accordance with the present invention is applied to a connected hose element 50 in place around the adapter 10, for example, as described in more detail hereinafter.

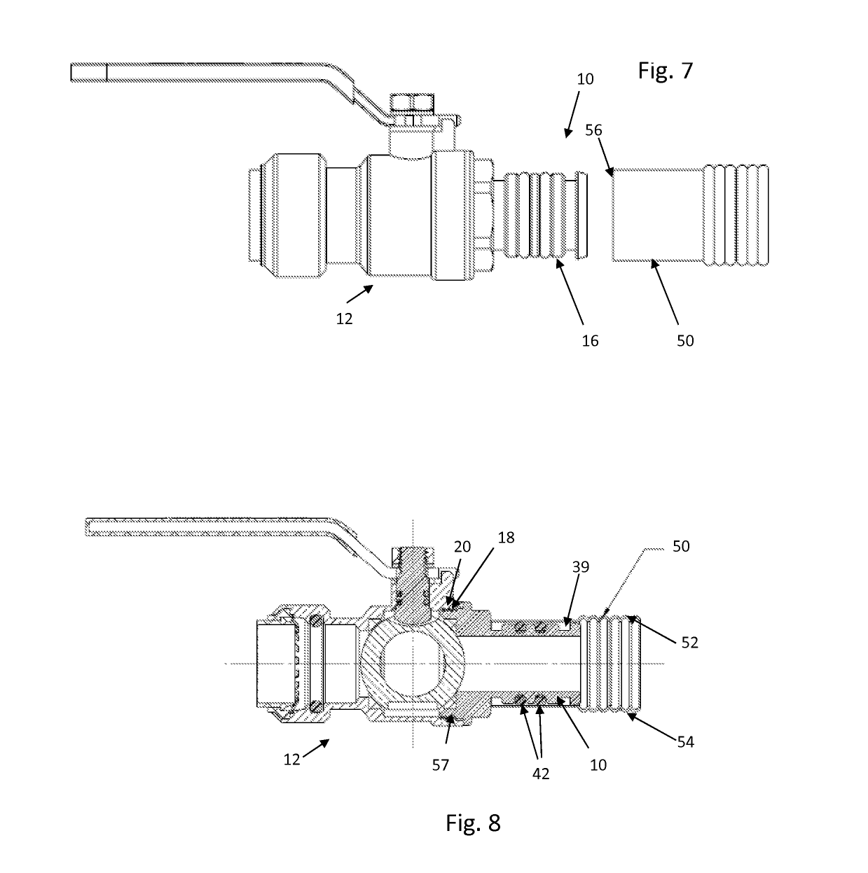

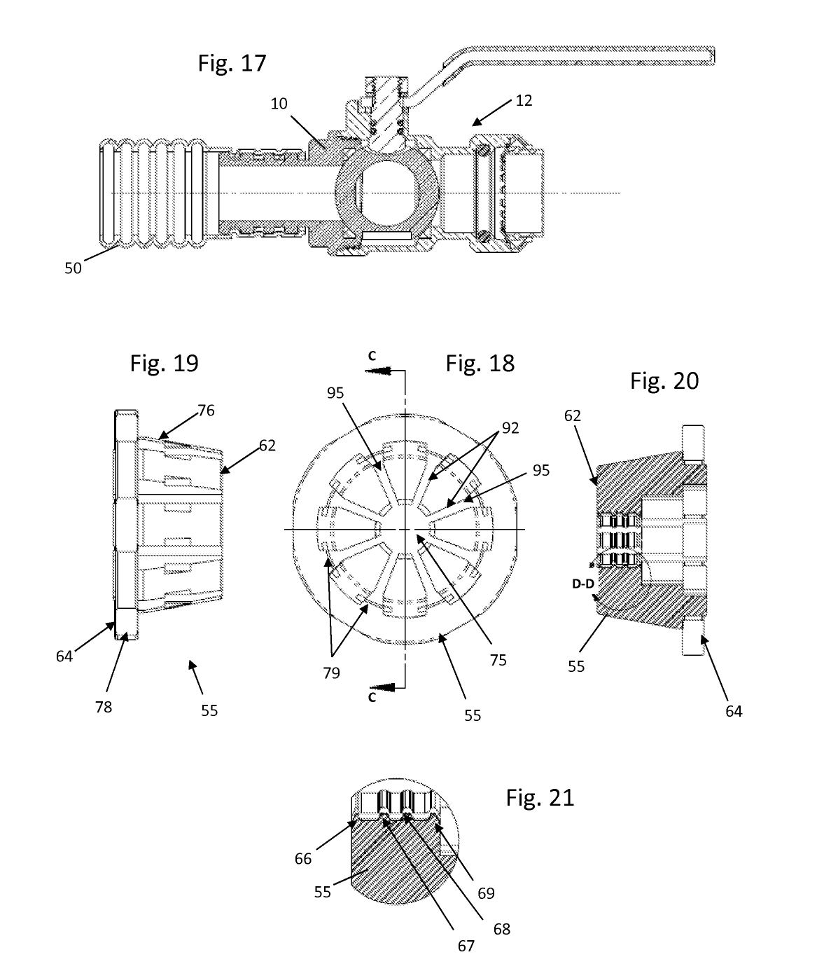

As shown in FIGS. 3, 8, 11-13, 15 and 17, the adapter end 18 adapted can be secured to an interior surface 57 of a fitting 12 either through a threaded/compression connection or a push-to-connect connection as described above. In such ways, the adapter 10 can be appropriately secured to the fitting 12, receive a hose element 50 and permit proper crimping of the hose element 50 to the adapter outer surface 16. FIG. 7 shows a hose element 50 prior to being secured around adapter outer surface 16. The hose element 50 is generally substantially cylindrical and/or tubular in shape, with an inner 52 and outer 54 surface. When secured around the adapter outer surface 16, the hose element 50 may be coined or otherwise physically manipulated such that the hose element inner surface 52 slidingly abuts the adapter outer surface 16 until the front edge 56 of the hose element 50 engages or nearly engages the stop surface 25, as shown in FIGS. 8 and 13 through 14. In this position, the assembly of the present invention according to these embodiments is ready for a crimping device 55 to be applied in order to securely seal the components together.

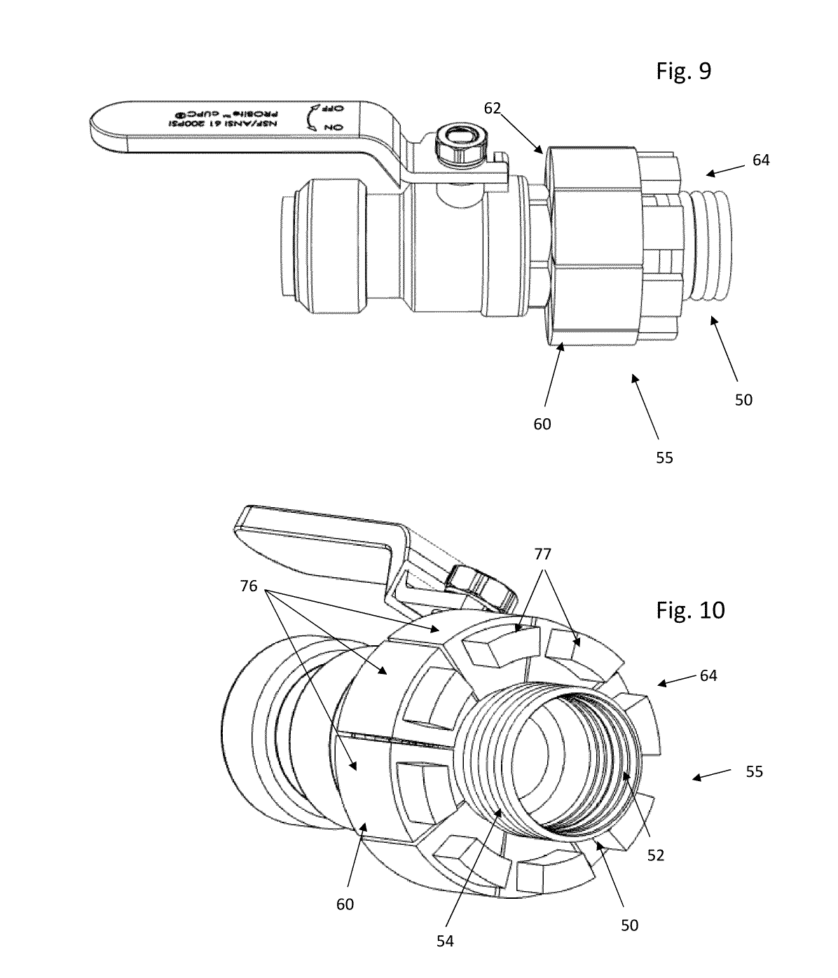

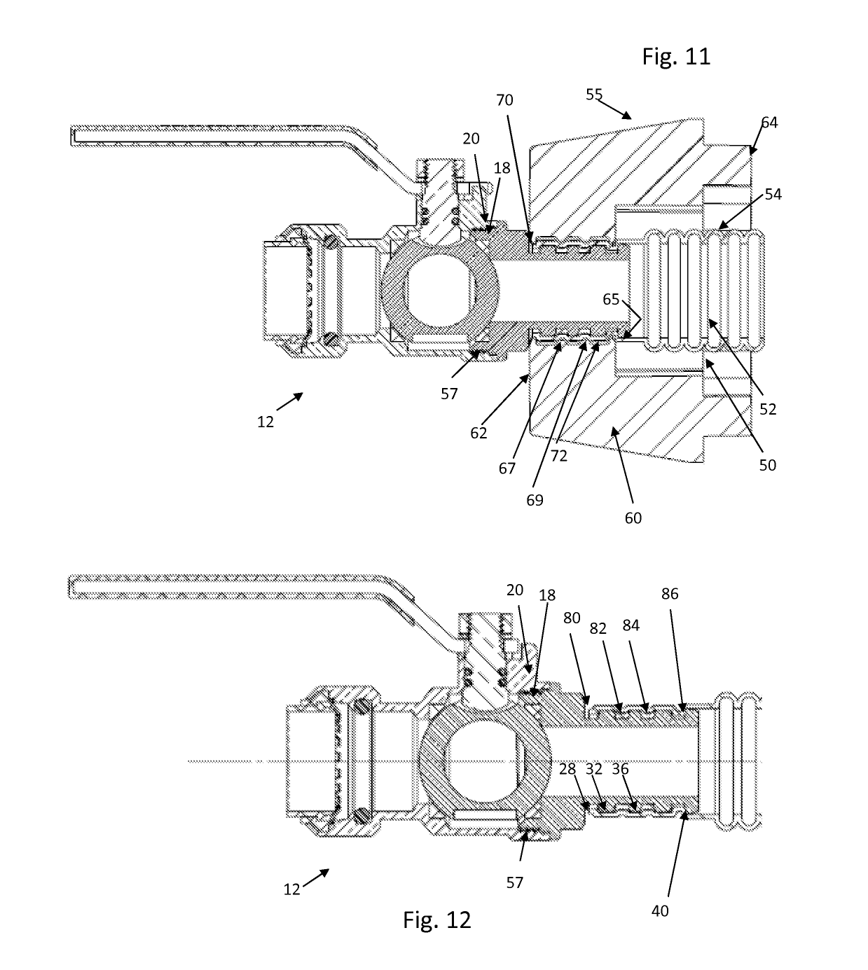

As shown in FIGS. 9 through 11, 13 through 16 and 18 through 21, the crimping device 55 can be provided as substantially cylindrical, tubular or frustoconical in shape, and can include a substantially cylindrical internal surface 65 defining an opening 75 through the body of the device 55, an external surface 60, and first and second end surfaces 62 and 64. In various embodiments, the internal surface 65 is adapted with one or more radial extensions 66, 67, 68, 69 extending towards the interior opening 75 of the crimping device 55. Such extensions 66, 67, 68, 69 can be spaced apart axially in order to substantially mate with o-rings 42 within the o-ring grooves 32, 36 of the adapter 10. In various embodiments of the present invention, the first end 62 of the crimping device 55 can be provided with a radially extending flange or tool retaining arch 70 for positioning between the stop surface 25 and the axial outer or leading edge 56 of the hose element 50 so as to be appropriately securely aligned prior to pressure being applied and crimping the hose element 50 to the adapter 10. In various embodiments, as shown in FIG. 11, for example, the radially inner surface 65 includes a radially extending ledge element 72 axially outwardly of the axially outermost radial extension 69. The ledge element 72 can engage the hose element 50 and crimp it so as to form an impression against the axially interior surface 41 (see FIG. 4) of the fourth radial ledge 40 of adapter 10. In various embodiments, as shown in FIGS. 4, 6, 8, 14 and 16, for example, the radially extending ledge element 72 is not provided, but a fourth extension 69 is provided for crimping the tube into a third groove 39.

In various embodiments of the present invention, multiple wedge elements 76 of the crimping device 55 extend from the second end 64 to the first end 62 of the crimping device 55 and each wedge element is provided with a respective jaw member 77 extending axially outwardly of the first end 62, as shown in FIGS. 9 through 10, 13, 15 and 18 through 21, for example. The wedge elements 76 can be connected by a common base, such as element 78 in FIG. 19, a series of one or more connector ring elements 79, as indicated in FIG. 18, or other securing element. Each wedge element has a pair of radially extending sides 92. The wedge elements 76 are connected so as to form gaps 95 between their radially extending sides 92, whereby the compression of the crimping device 55 causes the gaps 95 to narrow and the sides 92 to approach side-by-side engagement with respective neighboring wedge elements 76. The jaws 77 can be employed by a crimping machine (shown in part at 99) to appropriately seat the crimping device 55 during operation.

According to embodiments of the present invention, an adapter 10 is fixedly secured to a fitting, such as by threaded engagement or push-to-connect engagement, as described above, for example. The threaded engagement embodiment permits tightening and/or loosening by a wrench-type device engaging the hexagonal or appropriately shaped annular edge 24. Once the adapter 10 and fitting 12 are secured, o-ring elements 42 can be slid over the adapter body 15 and placed in position within o-ring grooves 32, 36. The hose element 50 can then be coined or otherwise manipulated over the axially outer edge 40 and circumferential lip 88 of the adapter 10, and slid over the adapter 10 until the hose element 50 reaches or approaches a stopping point 25 on the adapter 10. It will be appreciated that, as the hose is positioned over the adapter member 10, an axially outer portion 86 of the hose member 50 is crimped about the circumferential lip 88 of the fourth radial ledge 40, which provides for a first area of resistance to tensile force and restricts the tube from drifting, sliding or being pulled back off of the adapter when the crimping tool compresses the arrangement.

The crimping device 55 can then be positioned around the hose element 50, such that the first radial extension 66 is properly positioned near the stop surface 25 and above the leading edge 56 of the hose element 50. In this way, the radial extensions 67, 68 on the radially inner surface 65 of the crimping device 55 are properly aligned above the o-rings 42. When external pressure is applied to the crimping device 55, such as by a crimping machine 99, for example, the malleable hose element 50 is crimped as shown in FIGS. 11 through 12 and 15 through 17, for example, such that an axially inner portion 80 of the hose element 50 is bent into the axially interior groove 28 of the adapter 10. Other portions 82, 84, 91 of the hose element 50 are crimped and permanently depress the o-rings 42 in the o-ring grooves 32, 36, as shown in FIGS. 11 through 12 and 15 through 18, for example. An axially outer portion 86 of the hose element 50 is crimped around the fourth radial ledge 40 of adapter 10 as described above. The crimping machine can then release the crimping device 55, and the crimping device can then be removed. As a result of the crimping process, the embodiment of the device of the present invention comprising the adapter 10 and hose element 50, with fitting 12, is thereby provided with the desired physical characteristics and strength.

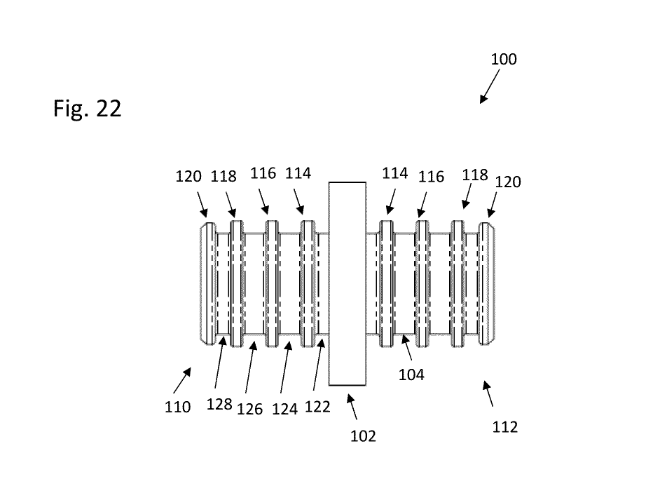

FIG. 22 shows an adapter member 100 in accordance with various embodiments of the present invention, including a rim 102 extending radially outwardly from the body portion 104 of the adapter member 100. The adapter member 100 includes first 110 and second 112 ends, and each end 110, 112 can be provided with multiple radial ledges 114, 116, 118 and 120 extending radially outwardly of the body portion 104. In various embodiments, the radial ledges 114, 116, 118 and 120 are provided such that the first 114, second 116 and third 118 radial ledges (counted beginning with the axially innermost ledge 114 adjacent the rim 102 on each end 110, 112) extend substantially the same radial distance from the body portion 104, while the fourth radial ledge 120 (the axially outermost) extends radially outwardly further from the body portion 104. In various additional embodiments, the axially innermost 114 and axially outermost 120 ledges extend radially outwardly further from the body portion than internal ledges 116, 118. In this way, the tube or hose element may have greater initial stress in passing over the ledges 114 and 120, but also have greater surface area contact with such ledges 114, 120. As a result of these factors, the subsequent crimping of the tube or hose element can provide a connection of increased strength. In various embodiments, the radially outward extension of axially innermost ledge 114 can extend further than the radially outward extension of axially outermost ledge 120. Grooves 122, 124, 126 and 128 are shown in between respective pairs of radial extensions 102, 114, 116, 118, 120, and one or more o-rings can be placed in one or more of such grooves prior to crimping a hose element about the adapter 100. By having an adapter 100 with one or more ledges 114, 116, 118, 120 on each end 110, 112, the present invention can accommodate fitting arrangements where multiple hose elements are being mated together with a single adapter.

It will be appreciated that the present invention provides various connection methods as described herein, as well as suitable valve embodiments, fitting embodiments and hose embodiments as described.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A fitting assembly, comprising:
a substantially cylindrical-shaped fitting component having at least one axially outer end, an outer wall, and an inner wall, wherein the inner wall defines a cavity extending axially through the main body component, with the inner wall at the at least one axially outer end having an adapter receiving structure;
an adapter member having an inner wall defining a cavity extending axially therethrough, the adapter member further having an outer wall with a first axial end and a second axial end, wherein the first axial end is formed so as to include a first and a second ledge extending radially outwardly from the outer wall and forming a first groove therebetween, wherein the first axial end is further formed so as to include a third ledge and a fourth ledge extending radially outwardly from the outer wall, wherein the fourth ledge extends radially outwardly at a position that is axially outward of the first, second and third ledges, wherein the first, second and third ledges extend substantially the same radial distance outwardly of the adapter member, and wherein the fourth ledge further extends radially outwardly further than the radially outward distance of the first, second and third ledges, respectively, and wherein the second axial end is adapted to engage the adapter receiving structure of the fitting component; and
at least one o-ring positioned within the first groove of the adapter member.

2. The assembly of claim 1, further including a tube member secured to the outer wall of the adapter member.

3. (canceled)

4. The assembly of claim 1, wherein the second and third ledges form a second groove therebetween, and further including at least one o-ring positioned within the second groove.

5. The assembly of claim 1, wherein the adapter member includes an axially outermost edge, and further wherein the fourth ledge includes a lip formed so as to extend radially outwardly further than the axially outermost edge.

6. The assembly of claim 5, wherein the third ledge and the lip of the fourth ledge form a third groove therebetween.

7. The assembly of claim 1, wherein the adapter member is formed so as to include a rim extending substantially radially outwardly from the outer surface between the first and second axial ends.

8. The assembly of claim 1, wherein the adapter member further includes a radially extending stop surface, wherein the stop surface and the first ledge of the adapter member form the sides of an axially interior groove.

9. (canceled)

10. The assembly of claim 9, wherein the first groove and the second groove extend radially inwardly into the adapter member outer surface further than the axially interior groove.

11. The assembly of claim 8, further including a tube member having an axially outer end, and wherein the tube member is secured to the outer wall of the adapter member such that the axially outer end of the tube member abuts the stop surface.

12. A method for providing a fitting assembly, comprising:
providing a substantially cylindrical-shaped fitting component having at least one axially outer end, an outer wall, and an inner wall, wherein the inner wall defines a cavity extending axially through the main body component, with the inner wall at the at least one axially outer end having an adapter receiving structure;
providing an adapter member having an inner wall defining a cavity extending axially therethrough, the adapter member further having an outer wall with a first axial end and a second axial end, wherein the first axial end includes a first and a second ledge extending radially outwardly from the outer wall and forming a first groove therebetween, and wherein the second axial end is adapted to engage the adapter receiving structure of the fitting component;
positioning a first o-ring within the first groove of the adapter member; and
securing the second axial end of the adapter member to the adapter receiving structure of the fitting component.

13. The method of claim 12 including the further step of securing a substantially cylindrical tube member having inner and outer surfaces to the outer wall of the adapter member by positioning the tube member over the outer wall of the adapter member, and applying pressure to the tube member outer surface so as to crimp the tube member about the outer surface of the adapter member.

14. The method of claim 13 wherein applying pressure to the tube member outer surface causes the tube member inner surface to compress the first o-ring within the first groove of the adapter member.

15. The method of claim 12 wherein the adapter member is further provided with a third ledge extending radially outwardly from the outer wall, wherein the second and third ledges form a second groove therebetween, and further including the step of positioning a second o-ring within the second groove of the adapter member.

16. The method of claim 15 including the further step of securing a substantially cylindrical tube member having inner and outer surfaces to the outer wall of the adapter member by positioning the tube member over the outer wall of the adapter member, and applying pressure to the tube member outer surface so as to crimp the tube member about the outer surface of the adapter member.

17. The method of claim 16 wherein applying pressure to the tube member outer surface causes the tube member inner surface to compress the first o-ring within the first groove of the adapter member and further to compress the second o-ring within the second groove of the adapter member.

18. The method of claim 15, wherein the adapter member is further provided with a fourth ledge extending radially outwardly from the outer wall of the adapter member, wherein the fourth ledge extends radially outwardly from the outer wall further than the radially outward distance of at least the second and third ledges.

19. The method of claim 12 wherein the adapter member is provided with a rim extending substantially radially outwardly from the outer surface of the adapter member between the first and second axial ends.

20. The method of claim 19, wherein the adapter member further includes an annular edge extending radially outwardly from the outer surface, wherein the annular edge includes an axially outer side forming a stop surface.

21. The method of claim 20, wherein the stop surface, the first ledge and the outer surface of the adapter member form an axially interior groove.

22. The method of claim 12 including the further step of providing a substantially cylindrical tube member having an inner surface, an outer surface, and an axially end surface, and further including securing the tube member to the outer wall of the adapter member by positioning the tube member over the outer wall of the adapter member, and applying pressure to the tube member outer surface so as to crimp the tube member about the outer surface of the adapter member.

23. The method of claim 22 wherein applying pressure to the tube member outer surface causes the tube member inner surface to compress the first o-ring within the first groove of the adapter member and further to compress the axially end surface of the tube member within the axially interior groove.

24. An adapter member for a fitting, comprising:
a substantially cylindrical body having an inner wall defining a cavity extending axially therethrough, the body further having an outer wall with a first axial end and a second axial end, wherein the first axial end includes a first and a second ledge extending radially outwardly from the outer wall and forming a first groove therebetween, and wherein the second axial end is adapted for one of push connection or threaded connection to an external fitting.

25. The adapter member of claim 24, further including a third ledge extending radially outwardly of the outer wall, wherein the second and third ledges form a second groove therebetween.

26. The adapter member of claim 24, wherein the second and third ledges extend substantially the same radial distance outwardly of the outer surface of the adapter member, and further wherein the first ledge extends a radial distance that is further outwardly of the outer surface of the adapter member than the radially outward distance extended by the second and third ledges.

27. The adapter member of claim 25, further including a fourth ledge extending radially outwardly of the outer surface of the adapter member, wherein the fourth ledge further extends radially outwardly of the outer surface further than the radially outward distance of at least the second and third ledges.

28. The adapter member of claim 27, wherein the fourth ledge has an external surface that slopes from an axially inner edge to an axially outer edge, such that the axially inner edge of the fourth ledge extends radially outwardly further than the axially outer edge of the fourth ledge.

29. An adapter member for a fitting, comprising:
a substantially cylindrical body having an inner wall defining a cavity extending axially therethrough, the body further having an outer wall with a first axial end and a second axial end, wherein the first axial end includes a first axial end first ledge and first axial end second ledge extending radially outwardly from the outer wall and forming a first axial end first groove therebetween, and wherein the second axial end includes a second axial end first ledge and a second axial end second ledge extending radially outwardly from the outer wall and forming a second axial end first groove therebetween.

30. The adapter member of claim 29 wherein each of the first and second axial ends includes a respective third ledge extending radially outwardly of the outer wall and a respective fourth ledge extending radially outwardly of the outer wall, wherein the respective second and third ledges form a second groove therebetween, and wherein the respective fourth ledges extend radially outwardly of the outer surface further than the radially outward distance of at least the respective second and third ledges of each of the first and second axial ends.
